(19) United States
(12) Patent Application Publication
(10) Pub. No.: US 2008/0163491 A1
(43) Pub. Date: Jul. 10, 2008

(54) CUTTING DEVICE

(75) Inventor: Scott D. Pearson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/969,034

(22) Filed: Jan. 3, 2008

Related U.S. Application Data
(60) Provisional application No. 60/883,360, filed on Jan. 4, 2007.

(51) Int. Cl. B25F 1/00

(52) U.S. Cl. 30/123

(57) ABSTRACT

The cutting device has (a) first and second members, each having opposing inside and outside surfaces, a cutting end, and a pivoting mechanism that allows the first and second members to be in communication with one other; (b) a cutting edge protruding from the inside surface of and disposed proximate to the cutting end of the first member; and (c) an extension protruding from the inside surface of and disposed proximate to the cutting end of the second member, wherein the cutting edge and the extension cooperate with one to cut the media when the cutting end of the first and second member are in a closed position.

### CROSS REFERENCE TO RELATED APPLICATIONS

This application claims priority to U.S. Provisional Patent Application Ser. No. 60/883,360 filed on Jan. 4, 2007, the disclosure of which is incorporated by reference in its entirety.

### FIELD OF INVENTION

The present disclosure provides a cutting device that optionally has dual functions of being capable of cutting open a sealed package while also closing an opened package.

### BACKGROUND

There are a wide variety of tools that have been described as having the capability of opening, cutting, or slitting sealed bags and also clipping, clamping, or clipping an opened bag. Illustrative references include 7,073,264 (Votolato); U.S. Pat. No. 6,629,327 (Adams); 6,578,243 (Hall); 6,105,217 (Caradine et al.).

There are a wide variety of tools that focus mainly on cutting packages as described in U.S. Pat. Nos. 5,561,905 (Sherman); 5,524,348 (Tipp); 5,103,562 (Braatz); 5,007,171 (Horning, Jr.); US Patent Application Publication 2005/0274026 A1 (Lee); and PCT Publication WO 98/30489.

There are some tools that are mainly directed to clamping elastomeric bags, such as those described in U.S. Pat. Nos. 5,428,871 (Iosif) and 4,394,791 (Groth).

While these devices may be useful for their intended purposes, other low cost, easy to manufacture cutting device that optionally includes a clipping or clamping feature is needed.

### SUMMARY

In one aspect, the present disclosure provides a device for cutting media. The device comprises (a) first and second members, each having opposing inside and outside surfaces, a cutting end, and a pivoting mechanism that allows the first and second members to be in communication with one other; (b) a cutting edge protruding from the inside surface of and disposed proximate to the cutting end of the first member; and (c) an extension protruding from the inside surface of and disposed proximate to the cutting end of the second member, wherein the cutting edge and the extension cooperate with one to cut the media when the cutting end of the first and second member are in a closed position.

One advantage of the present invention lies in its versatility in that it can be used to open sealed packages from both side edges of the device. In other words, a left handed or right-handed user can use the device. Also, unlike devices of the prior art, the inventive device cuts the sealed package completely from one edge of the package to the opposing edge. Some prior art devices require it to be inserted part way into the bag and a user can then cut the sealed package, leaving a portion of the package uncut. Furthermore, when the cutting ends of the first and second members of the inventive device are in an open state, a user has access to the cutting edge, allowing him or her to clean it, as necessary. Such a feature tends to be highly desirable after the device has been used on packages that contain food. As used herein, the cutting ends of the device are in an open state when they are not nearly immediately adjacent to one another.

### BRIEF DESCRIPTION OF THE DRAWINGS

The invention can be better described with reference to the drawings, wherein:

FIG. 1 is a perspective view of an exemplary combination device of the present invention;

FIG. 2 is a top plan view of the embodiment of FIG. 1;

FIG. 3 is a rear view of the embodiment of FIG. 1;

FIGS. 4a and 4b are perspective views of exemplary first and second members;

FIG. 5 is a side view of the members of FIGS. 4a and 4b aligned;

FIGS. 6a and 6b are perspective views of other exemplary first and second members;

FIG. 7 is a side view of the members of FIGS. 6a and 6b aligned;

FIGS. 8a and 8b are perspective views of yet other exemplary first and second members;

FIG. 9 is a side view of the embodiment of FIGS. 8a and 8b aligned;

FIGS. 10a and 10b are side views of yet other exemplary first and second members;

FIGS. 11a and 11b are side views of yet other exemplary first and second members; and

FIGS. 12a and 12b are side views of yet other exemplary first and second members.

These figures are idealized, are not drawn to scale and are intended only for illustrative purposes.

### DETAILED DESCRIPTION

In its fundamental form, the present disclosure pertains to a device for cutting media. The device can be a stand-alone device or adapted to an exiting bag clip that is commonly used to closed open packages. The device includes first and second members; each having at least a cutting end and each may have a clipping end. The device further includes a pivoting mechanism that connects and allows the first member to be in communication with or cooperate with the second member. Non-limiting examples of pivoting mechanisms include living hinges, mechanical devices, and biasing mechanisms. Non-limiting examples mechanical devices include clamps, bolts and screws, and latches. Non-limiting examples of biasing mechanisms include springs. A cutting edge protrudes from an inside surface of one of the members, such as, e.g., the first member, and an extension protrudes from an inside surface of the other member, such as, e.g., the second member. The cutting edge and the extension are disposed proximate to the cutting end of their respective members. The cutting edge and the extension can be disposed in practically any orientation on their respective members, so long as they cooperate with one another to facilitate cutting of the media.

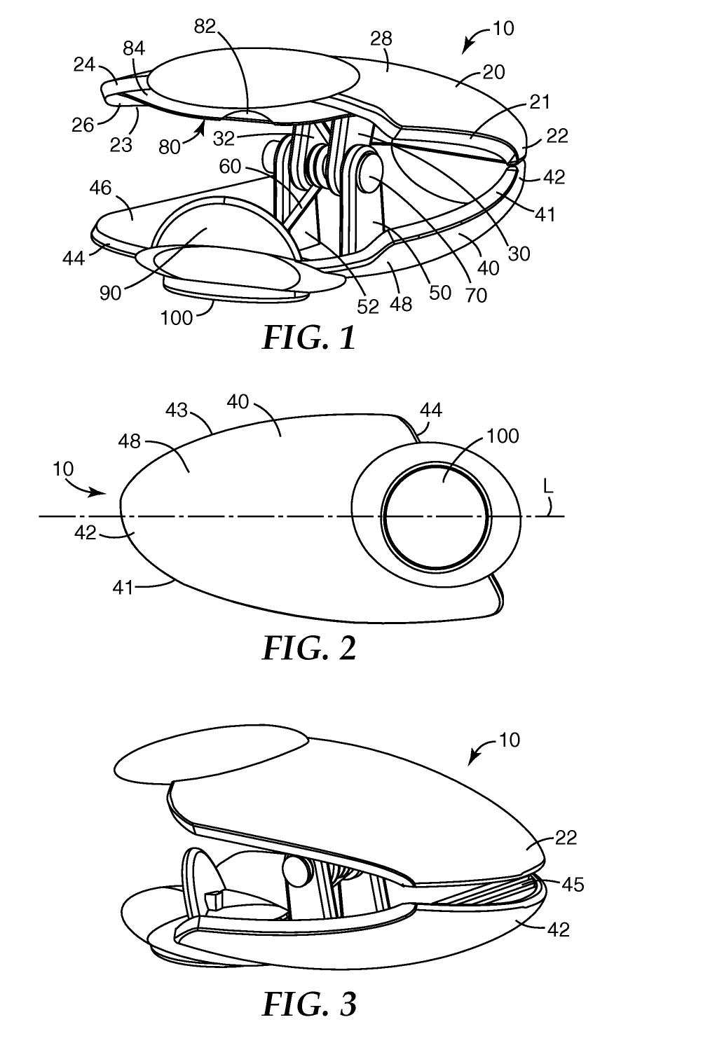

FIGS. 1 to 3 show various views of one exemplary device of the present disclosure. This particular device is capable of opening a sealed package and optionally clipping (i.e., closing) the opened package. Illustrative packages that may be used in the present invention include paper, plastic, foil lined packages, such as, but not limited to, envelopes, packages used for shipping hard good devices (e.g., cellular phones, sterilized dental equipment), food packages (e.g., potato chip bags). The device 10 includes a first member 20 having opposing clipping 22 and cutting 24 ends, and opposing inside surface 26 and outside surface 28. The cutting ends of the first and second members are angled. The device also includes a second member 40 having opposing clipping 42 and cutting 44 ends, and opposing inside 46 and outside 48 surfaces. Optionally, the clipping ends of the first and second members include gripping surfaces so as to better secure the package. Optionally, the outer surface of at least one of the first and second members also includes a magnet and or indicia thereon.

In this embodiment, the first and second members are substantially similar in geometry. The first and second members are also bound by side edges 21, 23 and 41, 43 respectively. The device has a longitudinal axis, denoted as L, traversing its length. The cutting end of each member ends include both substantially linear and rounded profiles while the clipping end of each member ends in a substantially rounded profile. Other profiles can be used for the cutting and clipping ends of the first and second members, and they may, but do not have to be, similar to one another.

A pivoting mechanism is disposed between the first and second members to cause one of the clipping and cutting ends to be in a closed position at any time. The pivoting mechanism is disposed between the clipping and cutting ends of each member. In this particular embodiment, the pivoting mechanism is biasing mechanism, and more specifically, a torsion spring 60. The spring includes a coil with first and second tangs extending from the ends of the coil. The torsion spring is held in place using a pair of first arms 30 and 32 extending from the inside surface of the first member, each of the first arm having an aperture and a pair of second arms 50 and 52 extending from the inside surface of the second member, each of the second arm having an aperture. A pin 70 connects the torsion spring and the first and second pair of arms together, the pin threaded into the apertures of the first and second arms and a center of the coil. Optionally, a magnet 100 may be added to at least one of the first and second members.

While FIGS. 1 to 3 include the use of a torsion spring, other biasing mechanisms may be used in the present invention, so long as the mechanism pivots one member against another to provide a clamping force needed when the device is in a clipping mode in clipping an opened package or when the device is in a cutting mode to open a sealed package.

The device further includes a guide 80 having a cutting edge 82, the guide protruding from the inside surface and proximate to the cutting end of the first member. In this particular embodiment, the cutting edge disposed in mounting wall 84. In one embodiment, the mounting wall are disposed substantially perpendicular to the longitudinal axis of the device. In another embodiment, the wall covers a portion of the cutting edge of the blade leaving a portion exposed. In yet another embodiment, the mounting wall extends over the cutting edge so as to limit, if not eliminate, a user's access. In alignment with the guide is an extension 90 protruding from the inside surface and proximate to the cutting end of the second member.

FIG. 1 shows the device in a clipping mode where the clipping ends of the first and members are nearly immediately adjacent to one another (referred to as a “closed position”) and the cutting ends are in an open position (i.e., the cutting ends of the first and second members are apart from one another). By applying a compressive force on the cutting ends of the first and second member thereby applying stress to the torsion spring, the device changes to a cutting mode where the cutting ends are in a closed position and the clipping ends are in an open position. In the cutting mode, a user can cut a package using several methods. In one exemplary method, the user closes the cutting ends to bring into contact the guide and then extension and then the user pulls the package or media to be cut through the closed cutting end thereby forcing the media into the cutting edge. In another exemplary method, the user closes the cutting end with the package or media between the cutting edge of the guide and the extension and then, the user pulls the media through to create the cut.

FIG. 3 shows the clipping ends of the device are in a slightly open position showing optional gripping surface 45 on the second member. If desired, a similar gripping surface may be added to the first member.

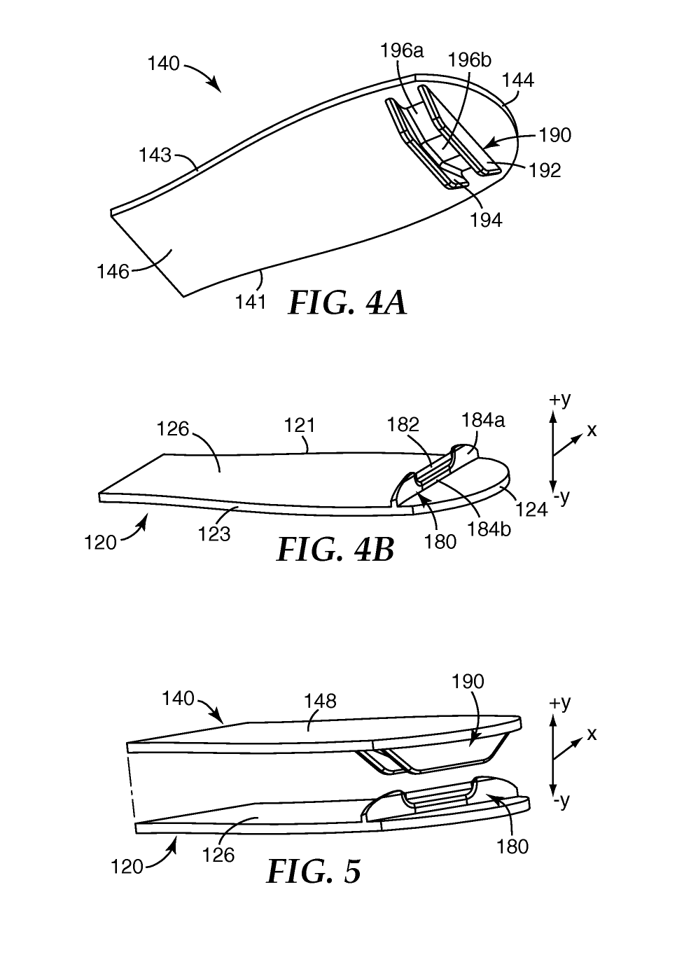

FIGS. 4A and 4B show portions of another exemplary first and second members FIG. 5 shows the embodiment of FIG. 4 where a cutting end 124 of the first member 120 is aligned with a cutting end 144 of a second member 140. For ease of understanding, a pivoting mechanism and the clipping ends of the first and second members have been omitted. The first member has an inside surface 126 and an opposing outside surface. Similarly, the second member has an inside surface 146 and an opposing outside surface 148. FIG. 5 shows that, when aligned, the inside surfaces of the two members are proximate to and facing each other. The first member further includes a guide 180 protruding from its inside surface and disposed proximate to the cutting end 124. In this embodiment, the guide includes a cutting edge 182 is disposed in a mounting wall that spans from about or near a first edge 121 to about or near a second edge 123. The mounting wall extends from an inside surface 126 of the first member. The mounting wall includes a midsection 184b sandwiched between two side sections 184a that lie adjacent to the first and second side edge.

The second member further includes an extension 190 protruding from it's inside surface and disposed proximate to the end cutting 144. This particular extension can be described as a cover having an inner region 196 disposed between two sidewalls, 192 and 194. The inner region includes a midsection 196b sandwiched between two outer sections, 196a, which are disposed proximate to side edges 141 and 143.

During cutting of media, when the cutting ends of the first and second members are nearly immediately adjacent to one another so that they are in a “closed position”, the cover is aligned with the guide such that the midsection 196b of the inner region 196 on the cover aligns or cooperates with the cutting edge. Preferably, in use, the uncut media enters the cutting end of the device above the cutting edge and exits the device below the cutting edge. To define the relative positions of the entry and exit of the media, if a two-dimensional coordinate system is placed on the cutting edge such that the x-axis lies parallel to the cutting edge and the y-axis lies perpendicular to the x-axis, “above” refers to the positive y direction while “below” refers to the negative y direction. The two-dimensional coordinate system is illustrated with reference to FIGS. 4b and 5 for illustrative purposes.

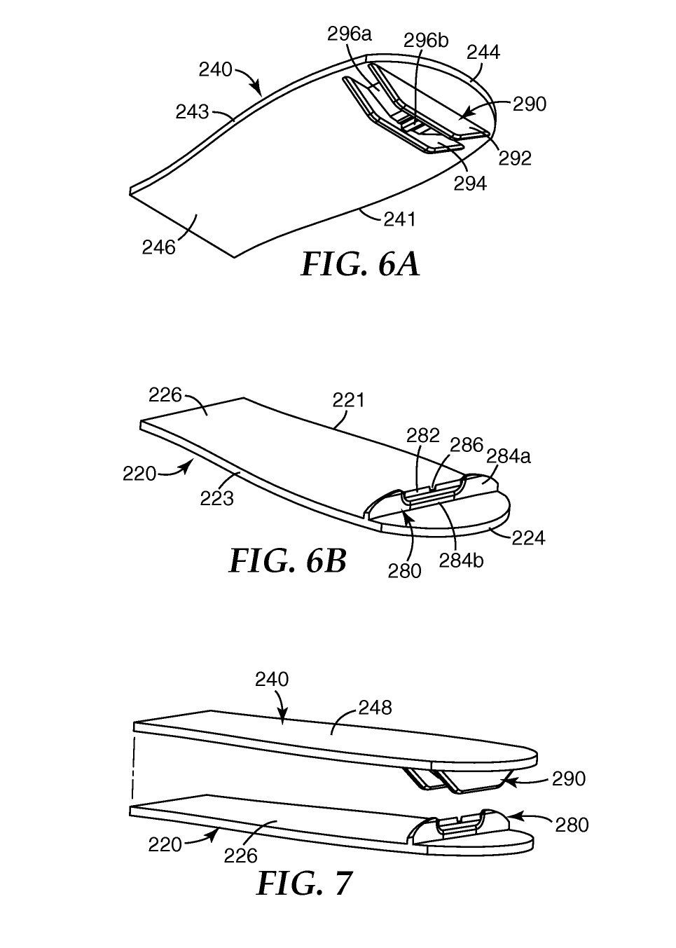

FIGS. 6A, 6B and 7 show portions of other exemplary first and second members. Proximate to a cutting end 224 of a first member 220 lies a guide 280 that has a cutting edge 282 having a groove 286. Also, proximate to a cutting end 244 of a second member 240 lays an extension 290. In this embodiment, the extension can be described as a cover that has an inner region 296 disposed between two sidewalls, 292 and 294. The inner region includes a midsection sandwiched between two outer sections, 296a, and the midsection having a notch 298. During cutting when the cutting ends of the first and second members are in a closed position, the cover is aligned or in communication with the guide such that the notch on the extension mates or aligns with the groove on the blade.

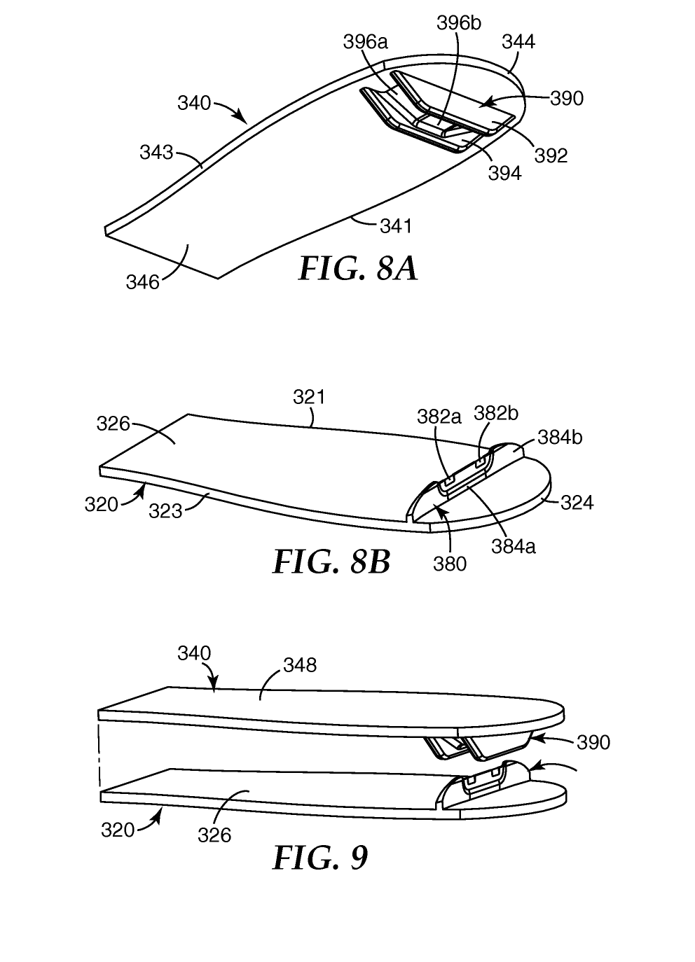

FIGS. 8A, 8B, and 9 show portions of yet other exemplary first and second members. In this embodiment, proximate to a cutting end 324 of a first member 320 lies a guide 380 that includes two cutting edges 382a and 382b. The guide further includes a mounting wall (collectively shown as sections 384a and 384b) where the cutting edge is disposed. Also, proximate to a cutting end 344 of a second member 340 lies an extension 390 that has an inner region 396 disposed between two sidewalls 392 and 394. The inner region includes a midsection 396b sandwiched between two outer sections, 396a. During cutting when the cutting ends of the first and second members are in a closed state, the extension is aligned with the guide. In this particular embodiment, the cutting edges are discontinuous thereby minimizing a user's exposure thereto. In one exemplary embodiment, a polymeric material lies in between the two cutting edges 382a and 382b.

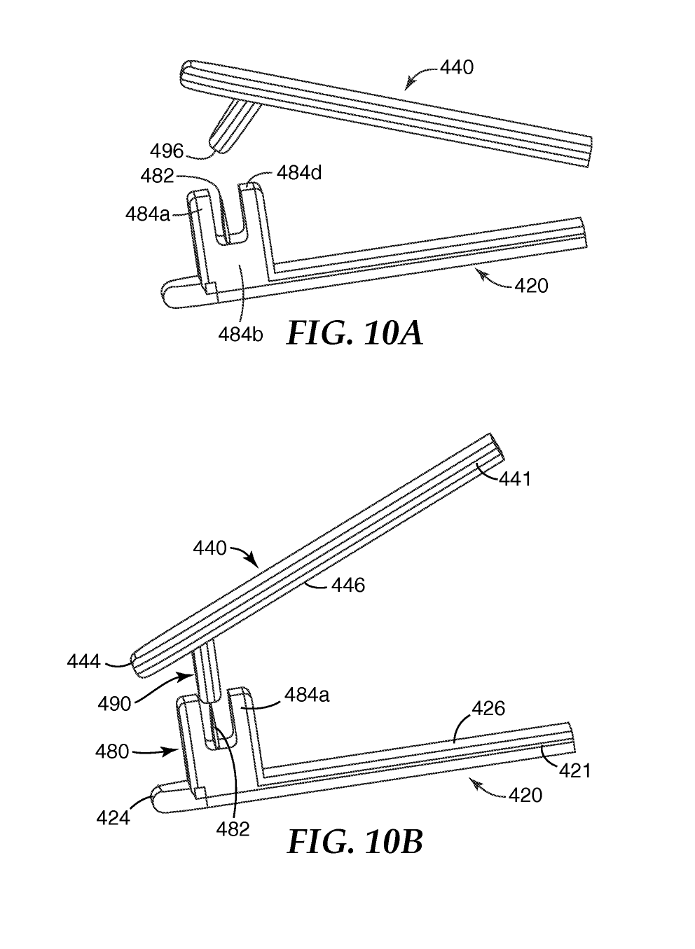

FIGS. 10A and 10B show side views of portions of yet other exemplary first and second members in open and closed positions, respectively. In this embodiment, proximate to a cutting end 424 of a first member 420 lies a substantially U-shaped guide 480 having two substantially symmetrical mounting walls 484a extending from and connected by a midsection 484b. The guide extends from about or near a first edge 421 to about or near a second opposing edge. In one embodiment, the guide has a width that is about the width of the first member. In this embodiment, a cutting edge 482 extends from the midsection and lies off-centered between the mounting walls, closer to the cutting end of the device. The cutting edge, however, may be positioned anywhere in the midsection. The position of the cutting edge in the midsection may have an impact on the amount of drag generated on the media when the device is used to cut the media.

The gap width between the two mounting walls is sufficiently small thereby limiting a user's access to the cutting edge. In one embodiment, the cutting edge lies below a top surface 484d of the mounting wall, thereby further limiting a user's access to the cutting edge. Also, proximate to a cutting end 444 of a second member 440 lays an extension 490 that protrudes from an inner surface 446. With reference to the inner surface, the extension protrudes therefrom non-perpendicularly, i.e., at an angle other than about 90 degrees. During cutting, when the cutting ends of the first and second members meet one another so that the extension is in communication with the guide, a tip 496 of the extension meets the cutting edge.

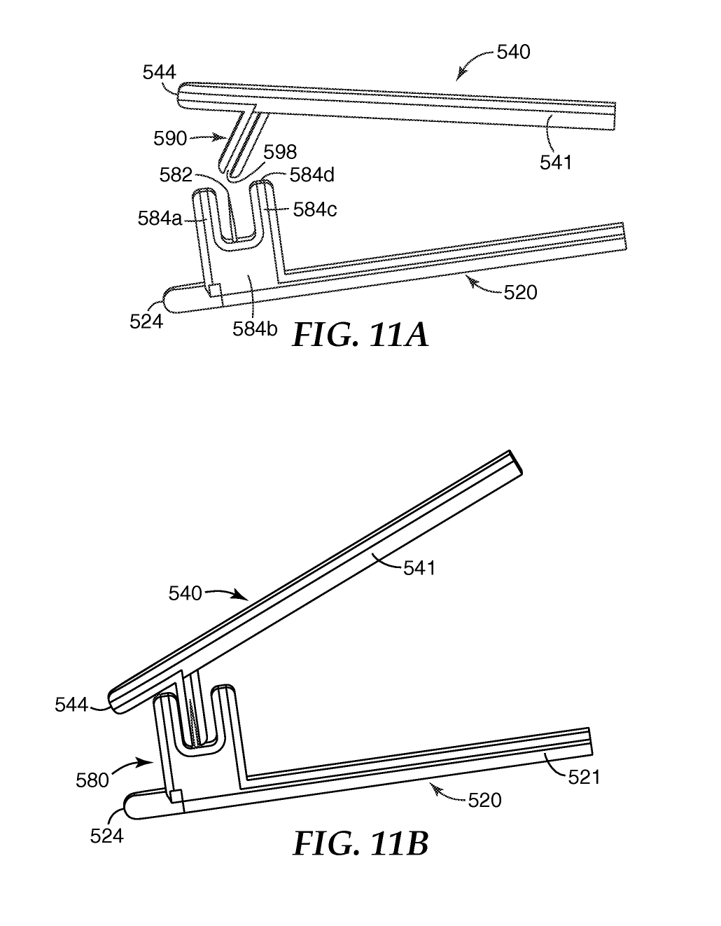

FIGS. 11A and 11B show side views of portions of yet other exemplary first and second members similar to that of FIGS. 10A and 10B. Near a cutting end 544 of a second member 540 lays an extension 590 having a slot 580. During cut, when the cutting ends of the first and second members meet one another, the cutting edge mates with the slot of the extension. In this embodiment, the cutting edge can be serrated thereby allowing the device to puncture or perforate the media. The puncture can then be propagated in the media to, e.g., open a plastic package by hand tearing along and beyond the initial perforation, as desired. Furthermore, if desired, the device can be used to puncture or perforate the media multiple times creating a plurality of punctures or perforations. In one application, the device can be used to puncture or perforate an edge of a package allowing for easier tearing of the package than without the puncture or perforation. Multiple punctures or perforations can be created along the edge as well, if desired.

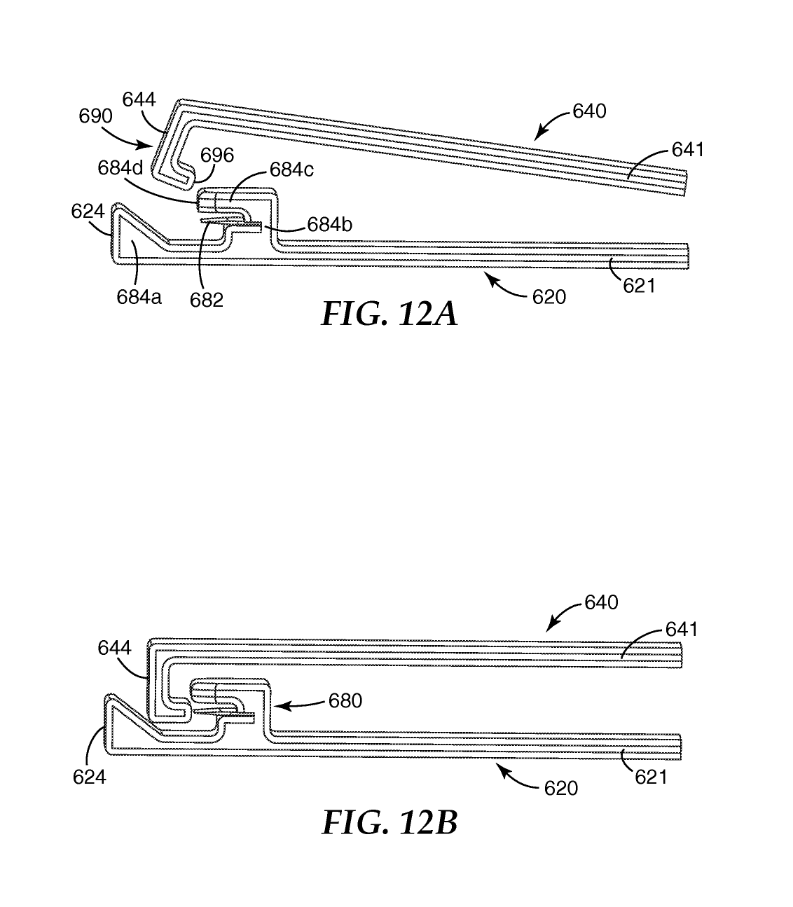

FIGS. 12A and 12B show side views of portions of yet other exemplary first and second members. In this embodiment, proximate to a cutting end 624 of a first member 620 is a guide 680 having a first mounting wall 684a with a ramp and a flat section, a midsection 684b connecting the flat section of the first mounting wall to a second mounting wall 684c. A cutting edge 482 extends from the midsection. In one embodiment, the cutting edge is positioned in the guide so as to limit a user's access to it. Also, proximate to a cutting edge 644 of a second member 640 is a substantially L-shaped extension 690 having a tip 696 and a corner 694. During cutting, when the first and second members are brought together, the corner of the extension meets with the ramp of the first mounting wall in the guide. In one embodiment, the extension is flexible. As with the other embodiments, the extension and the guide extend substantially from about or near first edge of their respective members to about or near a second edge.

In one embodiment, the device of the present invention is formed integrally. It is within the scope of the invention, however, for the various parts to be formed separately and thereafter joined together by any suitable means. For example, the first member can be formed separately from the second member and the two are assembled using any suitable means. Whether or not integrally formed, the device can be made from a variety of materials, including metal, wood, polymer, ceramics, and combinations thereof. Injection molded polymers are also useful. Suitable injection molded polymers include, but are not limited to, polyolefins (such as, but not limited to, polypropylene, polystyrene, high impact polystyrene) and acrylonitrile-butadiene-styrene copolymer. Each of the first and second members can be made from a combination of polymers as well. For example, the first and second member can be made of a first polymer and a second polymer, typically a softer polymer (as reflected in the durometer value) than the first polymer, can be over molded on the first polymer to provide a soft touch effect. If desired, different colors can be used for the first and second polymers to provide additional aesthetic appeal to the consumer.

While the cutting edge, which may be part of a blade, is shown to be substantially a straight, linear edge extending from the leading edge to the trailing edge, other designs can be used. For example, the cutting edge may be beveled, chiseled, serrated, corrugated, scalloped, or curved. The blade or any means for cutting the media can be of any number of geometries, such as, but not limited to, triangular, rectangular, or circular. The circular geometry can be advantageous in that if the cutting edge becomes dull, the cutting edge can be rotated so that a new section of the circular cutting edge will be exposed for cutting. If desired, an advancing mechanism can be added to the device to allow for rotation of the cutting edge. The cutting edge can be made from a wide variety of materials, including metals, ceramics, and plastics. Suitable metals include, but are not limited to, stainless steel, cold rolled steel, cold roll nickel plated steel, copper, and brass. The use of plastic blades or serrated plastic blades are particularly advantageous because they can simplify the manufacturing molding or assembly process by eliminating extra processing steps that may be required to insert or attach a metal or ceramic blade thereby reducing the cost of the device.

The extension can be made from a variety of materials, including, metal, ceramic, polymer, and polymer coated metal.

Although specific embodiments of the present invention have been shown and described, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A device for cutting media comprising:
first and second members, each having opposing inside and outside surfaces, a cutting end, and a pivoting mechanism that allows the first and second members to be in communication with one other;
a cutting edge protruding from the inside surface of and disposed proximate to the cutting end of the first member; and
an extension protruding from the inside surface of and disposed proximate to the cutting end of the second member,
wherein the cutting edge and the extension cooperate with one to cut the media when the cutting end of the first and second member are in a closed position.

2. The cutting device of claim 1 having a longitudinal axis along its length and wherein the first member is elongated and has opposing clipping and cutting ends and opposing inside and outside surfaces, wherein the second member is elongated and has opposing clipping and cutting ends and opposing inside and outside surfaces such that the respective clipping and cutting ends of the first and second members are aligned and the inside surfaces of the first and second members are proximate to one another and the pivoting mechanism is disposed between the first and second members and between their respective clipping and cutting ends.

3. The device of claim 1 wherein the clipping end of at least one of the first and second members includes a gripping surface.

4. The device of claims 1 wherein the cutting edge is discontinuous.

5. The device of claim 1 wherein the pivoting mechanism is selected from the group consisting of a living hinge, a mechanical device, and a biasing mechanism.

6. The device of claim 5, wherein the mechanical device is selected from the group consisting of a clamp, a bolt and screw, and a latch and wherein the biasing mechanism is a spring.

7. The device of claim 5, wherein the biasing mechanism is a torsion spring having first and second tangs, the first tang in contact with the inside surface of the first member, the second tang in contact with the inside surface of the second member.

8. The device of claim 1, wherein the cutting edge is disposed below a top edge of a mounting wall extending from the inside surface of the first member.

9. The device of claim 2, wherein the extension is a beam that protrudes non-perpendicular from the inside surface of the first member and the cutting edge is disposed off-centered in a substantially U-shaped guide.

10. The device of claim 9, wherein the beam includes a slot such that when the cutting ends are in a closed position, the cutting edge lies within the slot.

11. The device of claim 9, wherein the cutting edge is serrated.

12. The device of claim 1, wherein the cutting edge comprises a groove and the extension comprises a notch that cooperates with the groove to cut media when the cutting ends of the first and second members are in a closed position.

13. The device of claim 1, wherein the extension is made from a material selected from the group consisting of metal, ceramic, polymer, and polymer coated metal.

14. The device of claim 1, further comprising a magnet disposed on the outside surface of at least one of the first and second member.

15. The device of claim 1, wherein the outside surfaces of at least one of the first and second members include indicia.

16. The device of claim 1 formed from a material selected from the group consisting of metal, polymer, wood, ceramic, and combinations thereof.

17. The device of claim 1 made from a polymeric material selected from the group consisting of polypropylene, polystyrene, high impact polystyrene, polycarbonate, and acrylonitrile-butadiene-styrene copolymer.

18. The device of claim 1, wherein at least one of the first and second members is formed of two different polymers wherein a first polymer has a different property from a second polymer, the property selected from a group consisting of durometer, color, and combination thereof.

19. The device of claim 2, wherein the extension is substantially L-shaped and the cutting edge is disposed in a guide comprising a first mounting wall having a ramp connected to a flat section and a mid-section connecting the first mounting wall to a second mounting wall and wherein

20. The device of claim 19 wherein during cutting, the extension contacts the ramp of the first mounting wall.

21. The device of claim 1 wherein during cutting, the device creates a plurality of punctures and perforations the media.

22. The device of claim 1 wherein during cutting, the device creates at least one puncture along an edge of the media.

23. The device of claim 1, wherein the cutting edge is not accessible to a user whether the device is in a clipping or cutting state.
